(19) United States
(12) Patent Application Publication
(10) Pub. No.: US 2015/0362617 A1
(43) Pub. Date: Dec. 17, 2015

(54) AZIMUTHAL GAMMA RESOLVER ASSEMBLY

(71) Applicant: REME, L.L.C., CONROE, TX (US)

(72) Inventors: BRAD MUNOZ, HOUSTON, TX (US); ABRAHAM ERDOS, HOUSTON, TX (US); KENNETH MILLER, HOUSTON, TX (US); JOSHUA CARTER, CONROE, TX (US); JAMES MATHIESON, CONROE, TX (US)

(73) Assignee: REME, L.L.C., CONROE, TX (US)

(21) Appl. No.: 14/738,283

(22) Filed: Jun. 12, 2015

Related U.S. Application Data
(60) Provisional application No. 62/011,821, filed on Jun. 13, 2014.

(51) Int. Cl. G01V 5/04; E21B 47/00

(52) U.S. Cl. CPC G01V 5/045; E21B 47/00

(57) ABSTRACT

An improved azimuthal gamma radiation measurement assembly configured to facilitate downhole measurement of naturally occurring radiation and the correlation of measurement information with highly accurate orientation information. The azimuthal gamma radiation measurement assembly includes a resolver section that receives azimuthal gamma sensor inputs, correlates those inputs with orientation information, and logs the combined data set for further evaluation.

### BACKGROUND

1. Field of the Invention

The present invention relates to downhole radiation measurement assemblies.

2. Description of the Related Art

Downhole radiation measurement assemblies have been used in drilling operations for some time. In downhole drilling it is useful identify sub-surface rock formations and customize drilling assemblies and drilling methods to suit a particular geological formation. This can be useful when, for example, a drilling rig has been configured to be effective for a particular type of rock formation and characteristics of the rock formation change as the wellbore extends deeper beneath the surface. It would thus be useful to identify rock formations present at various drilling depths at a wellsite. Downhole radiation measurement assemblies measure the naturally occurring low level radiation that is given off by rock formations downhole. Different types of rock can give off differing amounts of radiation or radiation having other differing characteristics and if measured accurately, the type of rock formations at different depths can be identified. Often, radiation measurement assemblies are deployed downhole and many measurements are taken at different depths in a well. The sensor measurements can then be communicated to the surface and processed to determine the particular types of rock formations present at various depths at a particular wellsite.

Radiation measurement assemblies are commonly deployed with measurement while drilling tools. The purpose of measurement while drilling tools is to collect various sensor based measurements and facilitate the communication of the measurements to the surface. Measurement while drilling tools can be deployed with sensors for measuring various downhole conditions such as temperature, flow data, drillstring rotation, location information, radiation readings, or other useful downhole conditions. The sensors deployed alongside or as a part of measurement while drilling tools will often be configured to communicate data with the microcontroller or microprocessor that is a part of the measurement while drilling tool assembly deployed downhole. This communication may be made using standard protocols that transmit over bus connections between the measurement while drilling tool and the various sensors. Measurement while drilling tools can then communicate data from the sensors to the surface to remote computers or data logging equipment. Measurement while drilling tools can be deployed by wireline or inline with the drillstring and can include remote power supplies or receive power over cabling run downhole. It is common to deploy a radiation probe that is connected to a measurement while drilling tool downhole to perform radiation measurements at various depths. The measurement while drilling tool can be configured to receive gamma probe data, which for example may be in the form of a pulse train, and then process and communicate the data to remote computers on the surface. Measurement while drilling tools can also just run off of battery power and remotely log data that will later be retrieved when the tool returns to the surface. Some tools will take an additional approach where some data is sent to the surface in real-time and other data is logged to tool memory for later retrieval when the tool returns to the surface.

A particular subset of downhole radiation measurement assemblies includes azimuthal gamma radiation measurement assemblies. Azimuthal gamma assemblies can include one or more azimuthal gamma probes that measure radiation downhole. Azimuthal gamma assemblies can include a microcontroller, memory, and one or more azimuthal gamma probes, among other components. Probe measurement data can be logged and/or sent to the surface as measurements are taken. The measurement of gamma radiation facilitates the determination of downhole rock formations and also the verification of well placement in directional drilling applications. The precise identification of well placement can be particularly important and is often facilitated by azimuthal gamma measurement.

To this regard, omni-directional or bulk azimuthal gamma measurements have seen use downhole. Though omni-directional or bulk gamma measurements are sufficient for many applications, in highly stratified formations or while drilling along bed boundaries, omni-directional information is generally not sufficient. To provide the operator with improved information regarding a formation, a highly accurate directional gamma measurement tool is desired.

In this field, Sonde probe based and collar based directional radiation tools have seen some commercial use. In collar based tools, the gamma data interpretation and binning is complicated due to the lack of available orientation information. Current solutions do not provide adequate resolution or reliability to accurately determine the orientation of the constantly spinning tool and/or drillstring. This information is particularly desirable for azimuthal gamma based measurement assemblies.

Regarding the orientation of the tool, orientation determination is generally well-known and well-studied in the field of aerospace. It would thus be desirable to adapt and apply some of the orientation determination techniques known in aerospace to the downhole tool environment. With regard to orientation determination, Kalman filtering techniques in particular have seen use for some time in the aerospace field. Kalman filtering allows for increased measurement accuracy and precision when multiple samples are being taken over time when error boundaries of the measurements are generally known or can be calculated. Kalman filtering works by comparing multiple measurements over a given time period, comparing them, and reducing the “noise” associated with the known potential for error or deviation in each respective measurement. Linear estimation techniques have also been applied to nonlinear systems through Extended Kalman filtering techniques. The specific techniques for handling nonlinearities vary based on the application, but they can be generally summarized as local linearization techniques. Particularly in regard to orientation estimation, the rotation matrices necessary to rotate the sensor frame into the earth frame are nonlinear, and therefore nonlinear filtering techniques must be used.

It would thus be desirable to implement a custom azimuthal gamma resolver assembly utilizing Unscented Kalman Filter orientation determination techniques, specifically for collar based deployment of a directional gamma tool. It would further be desirable for such a system to include magnetometers and/or accelerometers to provide data for orientation determination.

### SUMMARY OF THE INVENTION

The present invention provides an improved azimuthal gamma radiation measurement assembly to facilitate downhole measurement of naturally occurring radiation and correlation of measurement information with highly accurate orientation information. The azimuthal gamma radiation measurement assembly includes a resolver section that receives azimuthal gamma sensor inputs, correlates those inputs with orientation information, and logs the combined data set for further evaluation. The resolver section can include a microcontroller, memory, and input/output ports. Azimuthal gamma radiation measurements are received by the resolver section from gamma probes or other radiation measurement devices. Once deployed, the resolver section continuously or at an interval, calculates the orientation of the drillstring. The orientation of the drill string can be calculated using accelerometer and/or magnetometer readings. The readings can then be processed by the microcontroller of the resolver section optionally using a Kalman Filter or other similar processing techniques in determining orientation information. The orientation information is then correlated with the radiation measurement information, it may then be logged to memory and/or sent to the surface. Post processing can be run on the data to further analyze and/or prepare it for display to an end user.

### BRIEF DESCRIPTION OF THE DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 depicts an example block diagram of an azimuthal gamma resolver assembly.

FIG. 2 depicts an example side perspective view of an azimuthal gamma resolver assembly tool.

FIG. 3 depicts an enlarged view of an example azimuthal gamma probe housing of the azimuthal gamma resolver assembly tool of FIG. 2.

FIG. 4 depicts a block diagram of an example resolver section of an azimuthal gamma resolver assembly of FIG. 1.

FIG. 5 depicts an alternative block diagram of an example resolver section of an azimuthal gamma resolver assembly of FIG. 1.

FIG. 6 depicts an example unscented Kalman filter flow chart illustrating an example set of steps performed by an azimuthal gamma resolver assembly.

FIG. 7 depicts an example initialization function flow chart illustrating an example set of steps performed as part of the initialization of an azimuthal gamma resolver assembly.

FIG. 8 depicts an example measurement equation flow chart illustrating an example set of steps performed to facilitate the taking of azimuthal gamma measurements by the azimuthal gamma resolver assembly.

### DETAILED DESCRIPTION

The present invention provides an improved downhole measurement assembly to facilitate azimuthal gamma measurement and orientation data correlation. The downhole measurement assembly can also be referred to as an azimuthal gamma resolver assembly. The downhole measurement assembly and/or azimuthal gamma resolver assembly can include one or more azimuthal gamma probes to sense radiation given off by downhole formations. In a preferred embodiment the azimuthal gamma probes are provided near the outer portions of a downhole measurement assembly enclosure, the enclosure serving to protect the azimuthal gamma probes from the harsh conditions often found downhole.

The azimuthal gamma resolver assembly can further include an orientation assembly comprising one or more magnetometers and/or one or more accelerometers. The magnetometers and accelerometers can be configured to provide information that may be used or further processed to determine the orientation at least a portion of a section of drill string deployed downhole to which the azimuthal gamma resolver assembly is connected to or a part of.

The azimuthal gamma resolver assembly can also include one or more microcontrollers. At least one of the microcontrollers can be configured to receive output data from one or more gamma probes or other type of radiation measurement probe that are a part of the azimuthal gamma resolver assembly. At least one of the microcontrollers can be configured to receive orientation information from the orientation assembly, and can be further configured to calculate relative position information of the portion of the section of drill string deployed downhole from the orientation information, and at least one microcontroller can be configured to correlate and generate correlation information linking the relative position information and the output from the azimuthal gamma probes. In an embodiment, one or more memory elements can also be configured to store downhole measurement assembly executable code, azimuthal gamma probe data, relative position information, correlation information, and any other information that it may be desirable to log.

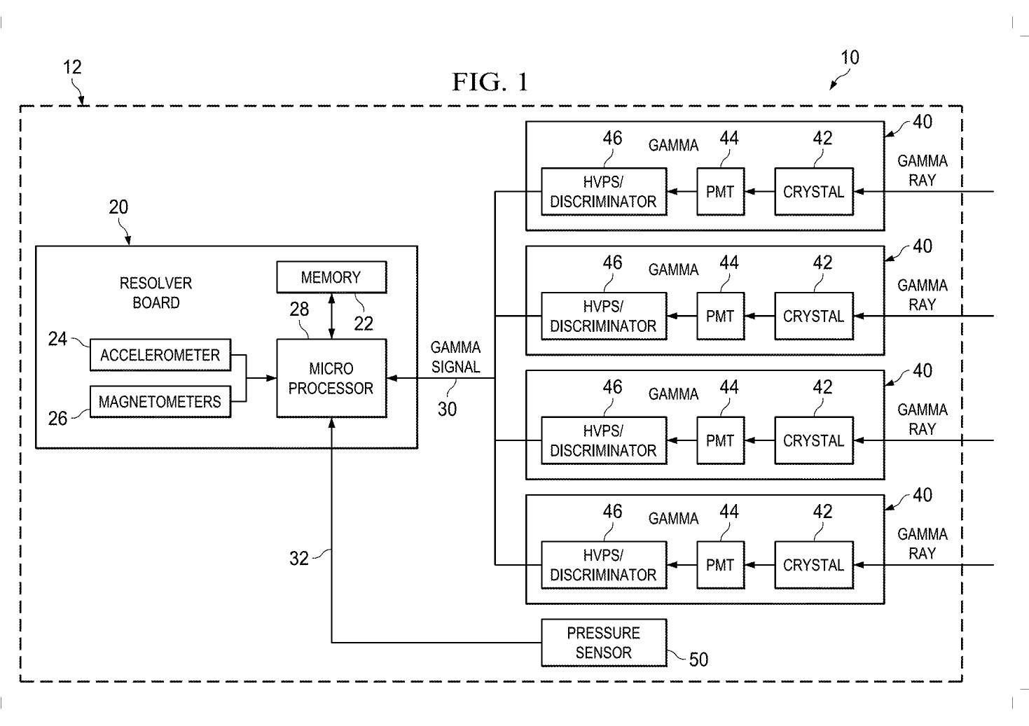

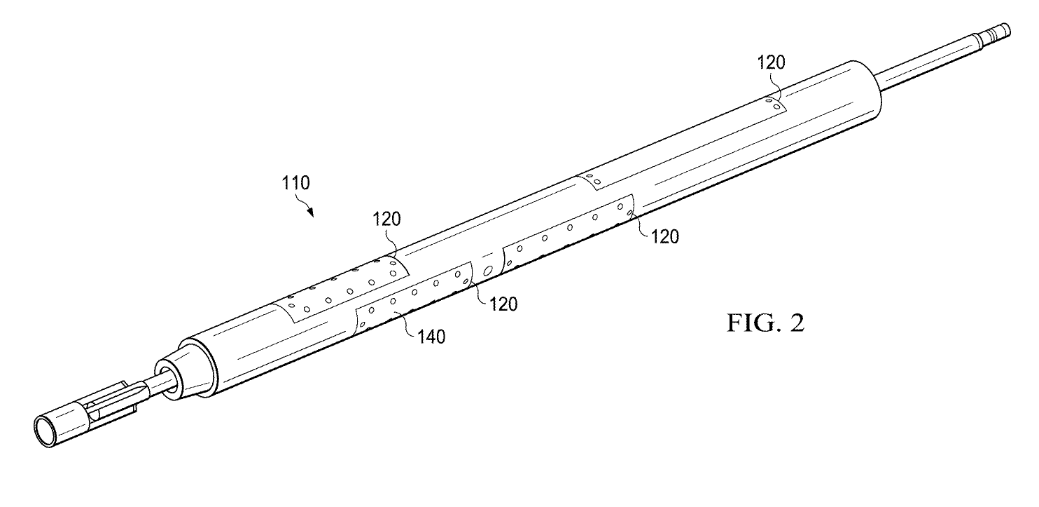

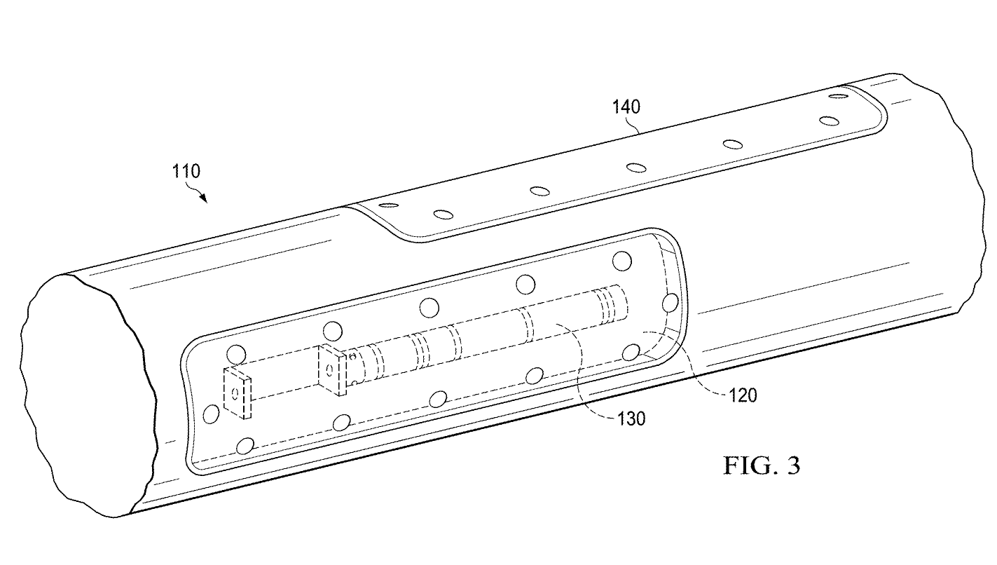

Referring to FIG. 1, an example block diagram of an azimuthal gamma resolver assembly 10 is shown as can be configured around a collar 12 of a downhole housing assembly (shown in FIGS. 2-3). In this example embodiment a resolver board section 20, includes one or more microprocessors 22 (can also be configured as one or more microcontrollers or one or more DSP's), one or more accelerometers 24, one or more magnetometers 26, one or more blocks of memory 28, one or more azimuthal gamma signal input lines 30, and a pressure sensor input line 32. While the diagram shows certain components grouped together, it should be recognized that each component can be configured or not configured, and if configured, can be configured on one or more boards and positioned at various areas throughout the downhole tool. The one or more azimuthal gamma signal input lines 30 connect to one or more gamma probes 40. Each gamma probe is configured with a receiver crystal 42, a photo multiplier tube (“PMT”) 44, and a high-voltage-power-supply (“HVPS”) and/or discriminator 46. In an embodiment the entire azimuthal gamma resolver assembly 10 is preferably housed in a non-magnetic downhole housing assembly sub (as shown in FIGS. 2-3). A pressure sensor 50 can also optionally be configured in the azimuthal gamma resolver assembly 10. Other sensors can also be configured and/or included in the azimuthal gamma resolver assembly 10.

Referring to FIGS. 2-3, an example embodiment of an azimuthal gamma resolver assembly tool chassis 110 is shown. Machined pockets 120 can be included for housing azimuthal gamma probes 130 or other electronic boards that may be included in the azimuthal gamma resolver assembly. Hatch doors 140 enclose and seal the probes and/or electronics from the downhole environment. In a preferred embodiment, azimuthal gamma probes having one inch diameter Sodium Iodine (NaI) crystal are configured, though modifications can be made to the tool 110 to accommodate other probe sizes and/or probe types. In addition to physical mounting space, in an embodiment the chassis of the tool 110 can be configured to provide vibration isolation to the gamma probes 130 to prevent damage to the probes when operating in highly dynamic environments.

In an embodiment, the azimuthal gamma resolver assembly tool can be configured with a high voltage power supply that can be housed in the tool chassis 110 or a nearby component to power the azimuthal gamma probes 130. In an embodiment, a gamma probe discriminator (as illustrated in FIG. 1) can be configured. A discriminator, when configured, takes signals from the gamma probe photo multiplier tube and outputs, for example, a negative 5 volt pulse, when a gamma signal over a given threshold is detected. Once a gamma signal is detected, the signal is sent from the gamma probe module to the azimuthal gamma resolver board assembly (as shown in FIG. 1). In a preferred embodiment, the resolver board assembly is housed in a separate pocket from the gamma probe assemblies.

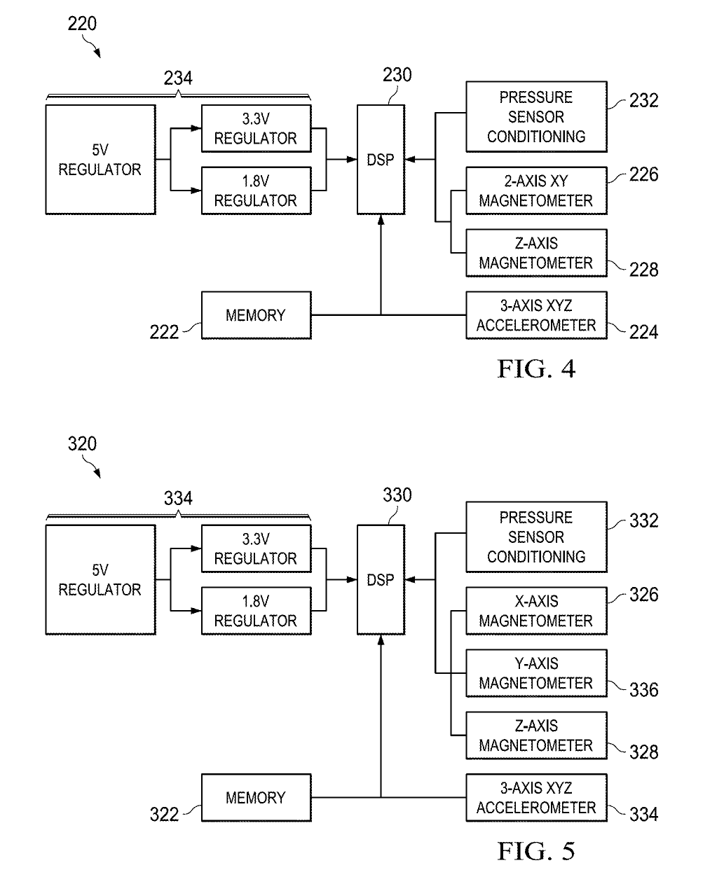

Once deployed, the azimuthal gamma resolver assembly can be configured to continuously and/or on a given interval calculate drill string section orientation information using the outputs from accelerometers and magnetometers that can be included as part of the azimuthal gamma resolver assembly. Referring to FIGS. 4-5, block diagrams are shown that illustrate example azimuthal gamma resolver board section configurations. For example, as shown in FIG. 4, a resolver board section 220 can be configured to include a 3-axis “xyz” 50 g accelerometer 224 and two magnetometers, the first magnetometer 226 of this example being configured as a 2-axis “xy” magnetometer and the second magnetometer 228 being configured as a single axis “z” magnetometer. In a preferred embodiment, the various axis's are configured to be aligned, however, it should be understood that the axis's may be configured out of alignment with known or measureable offset values being used to align the data between the same axis. Further, in a preferred embodiment the following may be configured: a DSP and/or microcontroller 230, a memory element 222, an optional pressure sensor conditioning element 232, and a voltage regulation section 234 that may include one voltage regulator or may optionally include multiple voltage regulators of varying output voltages.

Referring to FIG. 5, an alternate example configuration of an azimuthal gamma resolver board section is shown. Various embodiments of one or more accelerometers and one or more magnetometers can be configured. In the example embodiment shown the following elements are configured on a resolver board section 320: a 3-axis “xyz” accelerometer 334, an “x” axis magnetometer 326, a “y” axis magnetometer 336, a “z” axis magnetometer 328, a DSP and/or microcontroller 330, a memory element 322, an optional pressure sensor conditioning element 232, and a voltage regulation section 234 that may include one voltage regulator or may optionally include multiple voltage regulators of varying output voltages. This example demonstrates just one of the many possible configurations of accelerometer and magnetometer setups as well as DSP and/or microcontroller and associated equipment setups.

The one or more microprocessors, microcontrollers, and/or DSP's of the azimuthal gamma resolver board can be configured to run a resolver algorithm that provides highly accurate orientation information of the tool section housing the azimuthal gamma resolver assembly. In particular, a preferred resolver assembly can be configured to process the information provided by the accelerometers and magnetometers and any associated or calculated orientation information by using an Euler Angle Unscented Kalman Filter.

In an embodiment, the resolver board takes the inputs of the configured magnetometers and accelerometers and calculates orientation information for the tool, consisting at least of relative position information with respect to a pre-set or determined position of the tool. As the tool is deployed downhole and the drillstring is being rotated, the orientation of the tool can constantly change; this information can be tracked and logged to memory or communicated to the surface. Regarding the orientation information, it can be useful to process the information using an Unscented Kalman Filter. Generally, this will provide higher integrity orientation information as the Kalman Filter is capable of reducing the inherent error of individual measurements by leveraging information from a number of samples over a given observation window.

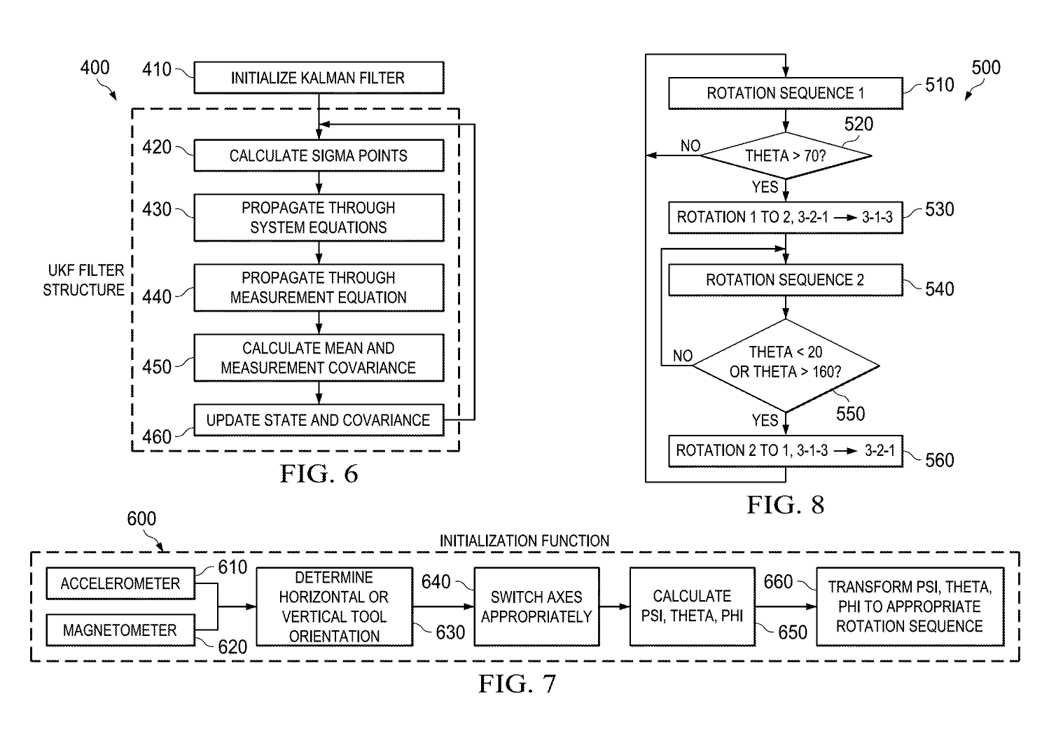

Referring to FIG. 6, in an embodiment, an Euler Angle Unscented Kalman Filter can assume four states of interest: psi, theta, phi, and rate of change of phi, wherein in this application these states are represented by azimuth, inclination, tool face, and rate of change of tool face. The three angles being a standard Euler Angle representation of orientation. While the state equations are linear, the observation matrix is nonlinear, and so an unscented transformation can be used to compute the observation matrix. Implementation challenges can include initialization and filter divergence near singularities. A flowchart of the overall filter structure 400 can be seen in FIG. 6. The Kalman Filter is first initialized 410. Sigma points are then calculated 420 and propagated through the set of system equations 430 and measurement equations 440. Mean and measurement covariance can then be calculated 450. Finally, the azimuth, inclination, tool face, rate of change of tool face, and covariance are updated 460 and the cycle continuously repeats as orientation information continues to be gathered and processed by the azimuthal gamma resolver assembly. Through this process each of the states, the azimuth, inclination, tool face, rate of change of tool face are all cycled through the Euler Angle Unscented Kalman Filter, thus providing highly accurate information due to being cycled through the filter. This can be highly beneficial in that the higher accuracy data can then be utilized by drilling personnel, offsite personnel, and/or the drilling systems themselves.

Referring to FIG. 7, an example initialization sequence 600 is shown. To initialize the Kalman Filter, a deterministic frame decomposition algorithm is used when the tool is powered on. Unlike a linear Kalman Filter, an Extended Kalman Filter needs to be well initialized to prevent divergence. Following a standard 3-2-1 Euler angle rotation sequence the method takes a single reading of the accelerometer 610 and magnetometer 620, and produces the azimuth, elevation, and roll quaternion. The method varies from others in that it is completely algebraic (no trigonometric functions). Similar decomposition methods are the Quest and TRIAD algorithms. However, this method is highly susceptible to noise and vibration due to the lack of feedback. Azimuth is particularly sensitive due to the dependence on both the accelerometer and magnetometer readings. Due to the sensitivity, it is preferred that the tool be powered up and initialized while, relatively, stationary. For example, the tool might be initialized with the drill string revolving at 60 rpms but 120 rpms may cause too much error in the initialization sequence. FIG. 7 shows an example implementation of an initialization function. After the accelerometer 610 and magnetometer 620 data is gathered, horizontal and/or vertical tool orientation is determined 630, axis are switched as appropriate 640, and psi, theta, and phi are calculated 650. Psi, theta, and phi are then transformed to the appropriate rotation sequence 660, thus concluding the initialization function 600.

The initialization algorithm provides an initial state estimate, x_hat, and covariance matrix, P_hat. These two parameters are fed into the Kalman Filter. A set of sigma points are then generated by taking the Cholesky decomposition of the P_hat following the methods of an Unscented Kalman Filter. These sigma points are propagated through the state equations, and, subsequently, through the measurement equation. To handle singularity issues, the algorithm switches between two Euler Angle sequences. A 3-2-1 rotation sequence, psi; theta; phi respectively, has singularities at theta of ±90 degrees while a 3-1-3 rotation sequence has a singularity at theta of 0 and 180 degrees. In the vertical section, the orientation algorithm uses a 3-2-1 rotation sequence, and in the horizontal a 3-1-3 rotation sequence. By looking at the second rotation parameter, 2 or 1, the filter can be switched from one rotation sequence to the other. A transformation is used to compute the angles from 3-2-1->3-1-3 and vice versa so that the filter avoids divergence issues due to poor initialization.

Referring to FIG. 8, a flowchart illustrating an example of the singularity avoidance and filter switching 500 is shown. The sigma points propagated through the measurement equation yield the expected observations. These observations can then be compared with the actual sensor measurements, and a posterior mean and covariance can then be calculated. The updated mean and covariance are then used to calculate Kalman gains, and the final step is to update the state estimate and covariance matrix. The state estimate and covariance matrix are returned and fed back into the filter on the subsequent iteration.

The azimuthal gamma resolver assembly additionally has two preferred modes of operation. One preferred mode involves a lower bandwidth binning of azimuthal gamma probe data by quadrant. As the drill string spins, the orientation information is further processed to determine what quadrant, 0-90, 90-180, 180-270, or 270-360, that the gamma readings were taken from. Once the quadrant has been determined, the probe data is correlated to the quadrant data. The probe data can be tagged with information denoting a particular quadrant or otherwise associated with that quadrant by storing the information in a data set for that quadrant. In an embodiment, the data can also be time-stamped so that it may later be correlated with depth information collected by the tool or at the surface. By correlating gamma probe data with highly accurate Kalman filtered orientation data, downhole formation information can be determined with substantially higher accuracy.

Another preferred mode involves a much higher bandwidth, more data intensive correlation and logging of information. In this mode, at a given time interval, substantially all of the Kalman filter calculation information, orientation information, and gamma probe readings are recorded. By recording more information over shorter time periods for pre-set intervals, the information gathered over longer runs can be more precisely verified.

When the azimuthal gamma tool passes formations with higher magnetite densities, it can be appreciated that magnetometer readings may contain greater error. When this is detected, the Kalman Filter can more heavily weight the accelerometer information versus the magnetometer information when calculating orientation. The will reduce the integrity of the orientation information over the zone necessary and as a result this data can optionally be tagged to indicate the reduction in orientation information integrity.

Though the mentioned flowcharts and configurations provide examples of the preferred form of practice and the concepts disclosed herein have been described in connection with the preferred form of practicing them and modifications thereto, those of ordinary skill in the art will understand that many other modifications can be made thereto. Accordingly, it is not intended that the scope of these concepts in any way be limited by the above description.

1. A downhole measurement assembly configured to facilitate azimuthal gamma measurement and orientation correlation, the downhole measurement assembly comprising:
one or more azimuthal gamma probes to sense radiation given off by downhole formations and to provide output representative of the radiation,
an orientation assembly comprising one or more magnetometers and one or more accelerometers,
one or more microcontrollers, at least one of which is configured to receive the output from the one or more of azimuthal gamma probes, and at least one of which is configured to receive outputs from the one or more magnetometers and one or more accelerometers, at least one of the one or more microcontrollers configured to process the accelerometer and magnetometer output data such that Euler Angle Unscented Kalman Filtered orientation information is output and includes each of azimuth, inclination, tool face, and rate of change of tool face, and at least one microcontroller configured to correlate the Kalman filtered orientation information and the outputs from the one or more azimuthal gamma probes based on time of collection information for the respective readings, thereby generating correlated orientation and gamma probe output data sets, and
one or more memory elements to store downhole measurement assembly executable code, orientation information, and correlated orientation and gamma probe output data sets.

2. The downhole measurement assembly of claim 1, further comprising:
one or more voltage regulators configured to provide power to the one or more microcontrollers, the one or more azimuthal gamma probes, and the one or more memory elements.

3. The downhole measurement assembly of claim 1, further comprising:
a communication pathway between each of the one or more azimuthal gamma probes and at least one of the one or more microcontrollers wherein the output pulses of each of the one or more azimuthal gamma probes are configured to communicate on the communication pathway to the at least one of the one or more microcontrollers for interpretation, correlation, and logging to memory.

4. The downhole measurement assembly of claim 1, further comprising:
a communication pathway between each of the one or more magnetometers and at least one of the one or more microcontrollers wherein the outputs of each of the one or more magnetometers are configured to communicate on the communication pathway to the at least one of the one or more microcontrollers for interpretation, correlation, and logging to memory.

5. The downhole measurement assembly of claim 1, further comprising:
a communication pathway between each of the one or more accelerometers and at least one of the one or more microcontrollers wherein the outputs of each of the one or more accelerometers are configured to communicate on the communication pathway to the at least one of the one or more microcontrollers for interpretation, correlation, and logging to memory.

6. The downhole measurement assembly of claim 3, wherein the one or more microcontrollers are configured to analyze the output pulses of each of the one or more azimuthal gamma probes and time correlate the pulses with accelerometer and magnetometer raw output information.

7. The downhole measurement assembly of claim 1, wherein the one or more microcontrollers are also configured to log the raw azimuthal gamma probe data correlated with time of collection information.

8. The downhole measurement assembly of claim 1, wherein the one or more microcontrollers are also configured to log the raw magnetometer output data correlated with time of collection information.

9. The downhole measurement assembly of claim 1, wherein the one or more microcontrollers are also configured to log the raw accelerometer output data correlated with time of collection information.

10. A method of measuring radiation given off by geological formations downhole, the method comprising the following steps:
deploying an azimuthal gamma radiation measurement assembly downhole, the measurement assembly comprising:
one or more azimuthal gamma probes to sense radiation given off by downhole formations and to provide output representative of the radiation,
an orientation assembly comprising one or more magnetometers and one or more accelerometers,
one or more microcontrollers, at least one of which is configured to receive the output from the one or more of azimuthal gamma probes, and at least one of which is configured to receive outputs from the one or more magnetometers and one or more accelerometers, at least one of the one or more microcontrollers configured to process the accelerometer and magnetometer output data such that Euler Angle Unscented Kalman Filtered orientation information is output and includes each of azimuth, inclination, tool face, and rate of change of tool face, and at least one microcontroller capable of being configured to correlate the Kalman filtered orientation information and the outputs from the one or more azimuthal gamma probes based on time of collection information for the respective readings, thereby having the capability to generate correlated orientation and gamma probe output data sets, and
one or more memory elements capable of storing downhole measurement assembly executable code, orientation information, and correlated orientation and gamma probe output data sets;
sensing the radiation given off downhole from formations by the one or more azimuthal gamma probes each generating pulses that are communicated to at least one of the one or more microcontrollers;
collecting a first output data from the one or more accelerometers;
collecting a second output data from the one or more magnetometers;
processing, by at least one of the one or more microcontrollers, the accelerometer and magnetometer first and second output data with an Euler Angle Unscented Kalman Filter such that azimuth, inclination, tool face, and rate of change of tool face are output as Kalman filtered orientation information.

11. The method of measuring radiation of claim 10, wherein the following additional step is included:
correlating, the Kalman filtered orientation information and the outputs from the one or more azimuthal gamma probes based on time of collection information for the respective readings.

12. The method of measuring radiation of claim 11, wherein the following additional steps are included:
generating, correlated Kalman filtered orientation information and gamma probe output data sets; and
storing, the respective correlated data sets to memory.

13. A downhole measurement assembly configured to facilitate azimuthal gamma measurement and orientation correlation, the downhole measurement assembly comprising:
one or more azimuthal gamma probes to sense radiation given off by downhole formations and to provide output representative of the radiation,
an orientation assembly comprising one or more magnetometers and one or more accelerometers,
one or more microcontrollers, at least one of which is configured to receive the output from the one or more of azimuthal gamma probes, and at least one of which is configured to receive outputs from the one or more magnetometers and one or more accelerometers, at least one of the one or more microcontrollers configured to process the accelerometer and magnetometer output data such that Euler Angle Unscented Kalman Filtered orientation information is output and includes each of azimuth, inclination, tool face, and rate of change of tool face, and at least one microcontroller capable of being configured to correlate the Kalman filtered orientation information and the outputs from the one or more azimuthal gamma probes based on time of collection information for the respective readings, thereby having the capability to generate correlated orientation and gamma probe output data sets,
one or more memory elements capable of storing downhole measurement assembly executable code, orientation information, and correlated orientation and gamma probe output data sets,
one or more communication pathways between each of the one or more azimuthal gamma probes and at least one of the one or more microcontrollers wherein the output pulses of each of the one or more azimuthal gamma probes are configured to communicate on the communication pathway to the at least one of the one or more microcontrollers for interpretation, correlation, and logging to memory,
non-transitory computer-readable storage medium in communication with the one or more microcontrollers with an executable program stored thereon, the executable program comprising a set of instructions that, when executed by the one or more microcontrollers, causes the one or more microcontrollers to perform the operations of:
sensing the radiation given off downhole from formations by the one or more azimuthal gamma probes each generating pulses that are communicated to at least one of the one or more microcontrollers;
collecting a first output data from the one or more accelerometers;
collecting a second output data from the one or more magnetometers; and
processing, by at least one of the one or more microcontrollers, the accelerometer and magnetometer first and second output data with an Euler Angle Unscented Kalman Filter such that azimuth, inclination, tool face, and rate of change of tool face are output as Kalman filtered orientation information.

14. A downhole measurement assembly as defined in claim 13, wherein the non-transitory computer-readable storage medium further comprises a set of instructions that when executed by the one or more microcontrollers, causes the one or more microcontrollers to perform the operations of:
correlating, the Kalman filtered orientation information and the outputs from the one or more azimuthal gamma probes based on time of collection information for the respective readings.

15. A downhole measurement assembly as defined in claim 14, wherein the non-transitory computer-readable storage medium further comprises a set of instructions that when executed by the one or more microcontrollers, causes the one or more microcontrollers to perform the operations of:
generating, correlated Kalman filtered orientation information and gamma probe output data sets; and
storing, the respective correlated data sets to memory.

16. A computer-implemented method to facilitate measuring radiation given off by geological formations downhole, the computer-implemented method comprising the following steps:
sensing the radiation given off downhole from formations by the one or more azimuthal gamma probes each generating pulses that are communicated to at least one of the one or more microcontrollers;
collecting a first output data from the one or more accelerometers;
collecting a second output data from the one or more magnetometers; and
processing, by at least one of the one or more microcontrollers, the accelerometer and magnetometer first and second output data with an Euler Angle Unscented Kalman Filter such that azimuth, inclination, tool face, and rate of change of tool face are output as Kalman filtered orientation information.

17. The computer-implemented method of claim 16, wherein the computer-implemented method further comprises the following step:
correlating, the Kalman filtered orientation information and the outputs from the one or more azimuthal gamma probes based on time of collection information for the respective readings.

18. The computer-implemented method of claim 17, wherein the computer-implemented method further comprises the following steps:
generating, correlated Kalman filtered orientation information and gamma probe output data sets; and
storing, the respective correlated data sets to memory.
